(19) United States
(12) Patent Application Publication
(10) Pub. No.: US 2014/0079172 A1
(43) Pub. Date: Mar. 20, 2014

(54) NUCLEAR REACTOR WITH DEVICE FOR INJECTING NANOPARTICLES IN THE EVENT OF AN ACCIDENT

(71) Applicants: Mehdi Moussavi, Paris (FR); Mickael Guillodo, Broye (FR); Marylise Caron-Charles, Versailles (FR)

(72) Inventors: Mehdi Moussavi, Paris (FR); Mickael Guillodo, Broye (FR); Marylise Caron-Charles, Versailles (FR)

(73) Assignee: AREVA, Paris (FR)

(21) Appl. No.: 14/116,302

(22) PCT Filed: May 10, 2012
(86) PCT No.: PCT/EP12/58679

§ 371 Date: Nov. 7, 2013

(30) Foreign Application Priority Data
May 11, 2011 (FR) 11 54072

(51) Int. Cl. G21C 15/18

(52) U.S. Cl. CPC G21C 15/18; Y10S 977/902; B82Y 30/00
USPC 376/282; 977/902

(57) ABSTRACT

A nuclear reactor is provided that includes a core with nuclear fuel assemblies; a circuit for cooling the core in which circulates a fluid coolant; and a device provided for injecting nanoparticles into the fluid coolant. The nanoparticles include first nanoparticles of a first type having a first form factor of less than two, and second nanoparticles of a second type different from the first type having a second form factor greater than two, the nanoparticles comprising between 10% and 90% by weight of the first nanoparticles and between 90% and 10% by weight of the second nanoparticles.

The present invention generally relates to nuclear reactors, notably to the dissipation of heat in such reactors during an accident of the LOCA (loss of coolant accident) type.

More specifically, the invention relates to a nuclear reactor of the type comprising:
a core having assemblies of nuclear fuel;
a circuit for cooling the core in which circulates a fluid coolant;
a device for projecting nanoparticles into the fluid coolant.

### BACKGROUND

Such a nuclear reactor is described in US 2008/0212733. An accident of the LOCA type in a nuclear reactor typically corresponds to a leak occurring in the circuit for cooling the core, such that a portion of the primary fluid coolant flows out of the cooling circuit and is collected at the bottom of the cavity of the reactor. Consequently, the assemblies of nuclear fuel are no longer cooled in an adequate way and the temperature in the core of the reactor increases. This increase in temperature may cause melting of the core. In reactors of the PWR and BWR type, an accident of the LOCA type for example corresponds to the failure of the main steam line connecting the vessel of the reactor to the steam generator or to the turbine, respectively.

The US document above provides the injection of nanoparticles into the primary fluid coolant in the LOCA case with view to increasing the heat exchanges in the cooling circuit. This injection is achieved as soon as the loss of liquid coolant is detected.

### SUMMARY OF THE INVENTION

In order to efficiently increase the heat exchanges in the circuit for cooling the core, the nanoparticles have to be dispersed in the liquid coolant and remain in suspension without settling.

In this context, the invention aims at proposing a nuclear reactor in which the injection of nanoparticles allows an increase in the heat exchanges in the circuit for cooling the core in an efficient and long-lasting way. In the case of an accident of the LOCA type.

For this purpose, the invention deals with a nuclear reactor of the aforementioned type, characterized in that the nanoparticles comprise first nanoparticles of a first type having a first form factor of less than 2, and second nanoparticles of a second type different from the first type, having a second form factor greater than 2, the nanoparticles comprising between 10% and 90% by weight of the first nanoparticles and between 90% and 10% by weight of the second nanoparticles.

The first nanoparticles, having a smaller form factor, withstand thermal impacts better and settle less, because they have a stronger uniformly distributed surface charge. The second nanoparticles, having a higher form factor, have stronger heat conductivity in solution but settle more rapidly. Surprisingly, the use of a mixture of nanoparticles of both types gives the possibility of benefiting from the advantages of both types of nanoparticles. The fluid coolant containing the mixture of the first and second nanoparticles has excellent heat conductivity. The nanoparticles practically do not settle, and the turbulences resulting from the circulation of the fluid coolant are sufficient for maintaining them in a suspension.

The nuclear reactor is a reactor of the PWR type, or a reactor of the BWR type, or any other type of reactor in which the core is cooled by circulation of a heat transfer liquid. This fluid coolant is typically water, but may be another heat transfer liquid.

The nanoparticles are typically nanopowders of metal oxides or of diamond.

Such nanoparticles are for example described in the article <<Surface wettability change during pool boiling of nanofluids and its effect on critical heat flux>> of Kim et al. published in the International Journal of Heat and Mass Transfer, 50 (2007) 40105-40116; or further in the article <<A feasibility assessment of the use of nanofluids to enhance the in-vessel retention capability in light water reactors>>, of Buongiorno et al., published in Nuclear Engineering and Design 239 (2009) 941-948 or further in the article <<Effects of nanoparticles deposition on surface wettability influencing boiling heat transfer in nanofluids>> of Kim et al. published in Applied Physics Letters 89, 153107 (2006).

The first nanoparticles are in a material identical with the material forming the second nanoparticles. Alternatively, the first nanoparticles and the second nanoparticles are in respective materials different from each other.

Preferably the first nanoparticles are in a mineral oxide, typically selected from Al₂O₃, ZnO, CeO₂, or Fe₂O₃. The second nanoparticles are also in a mineral oxide, typically selected from Al₂O₃, ZnO, CeO₂ or Fe₂O₃.

The first nanoparticles have a form factor of less than 2, preferably comprised between 1 and 1.5, still preferably comprised between 1 and 1.2. By form factor is meant here the ratio between the length of the nanoparticle and its width. The length corresponds to the largest dimension of the nanoparticle, this dimension being taken along a longitudinal direction of the particle. The width corresponds to the smallest dimension of the particle, taken in a plane perpendicular to the longitudinal direction.

Thus, for a sphere, the form factor is strictly equal to 1. Preferably the first nanoparticles are spherical or pseudo-spherical.

Typically, at least 50% of the first nanoparticles have a form factor comprised between 1 and 1.5, preferably at least 75% of the first nanoparticles, and still preferably at least 90% of the first nanoparticles.

The second nanoparticles have a second form factor greater than 2. The form factor is defined as earlier.

Preferably, the second nanoparticles have a form factor comprised between 2 and 5, and still preferably comprised between 2 and 3. For example, the second nanoparticles appear as rods, each rod having an elongated shape along a longitudinal direction.

Typically, at least half of the second nanoparticles have a form factor comprised between 2 and 5, preferably at least 75% of the second nanoparticles and still preferably at least 90% of the second nanoparticles.

The nanoparticles provided for being injected into the fluid coolant comprise between 10 and 90% by weight of first nanoparticles, preferably between 30 and 70% by weight of first nanoparticles and still preferably between 40 and 60% by weight of first nanoparticles. Conversely, the nanoparticles comprise between 90% and 10% by weight of second nanoparticles, preferably between 70% and 30% by weight of second nanoparticles, and still preferably between 60% and 40% by weight of second nanoparticles. For example, the nanoparticles include 50% by weight of first nanoparticles and 50% by weight of second nanoparticles.

Typically, the nanoparticles only comprise first nanoparticles and second nanoparticles, and do not include nanoparticles of another type.

The nanoparticles in majority have sizes comprised between 50 nanometers and 250 nanometers, before being agglomerated with each other as described later on. Preferably, at least 75% of the nanoparticles have sizes comprised between 50 and 250 nanometers, and still preferably 90% of the nanoparticles.

Preferably the nanoparticles in majority have sizes comprised between 75 and 150 nanometers, and still preferably comprised between 90 and 110 nanometers.

By size of a nanoparticle is meant here the largest dimension of said nanoparticles.

The nanoparticles before injection appear as agglomerates, each agglomerate including both first nanoparticles and second nanoparticles. Thus each agglomerate is an assembly including a plurality of first nanoparticles and a plurality of second nanoparticles, interdependent upon each other. Each agglomerate is therefore a monolithic assembly of small size. After injection of the nanoparticles into the fluid coolant, the agglomerates disperse and form a suspension. The agglomerates, within the fluid coolant, remain as a single piece, the nanoparticles making up each agglomerate remaining normally interdependent upon each other. The agglomerates may break up under the effect of impacts on the other hand, after a certain duration of circulation in the fluid coolant.

The agglomerates in majority have sizes comprised between 150 nanometers and 400 nanometers. Preferably, at least 75% of the agglomerates have a size comprised between 150 and 400 nanometers, and still preferably 90% of the agglomerates. Preferably, the majority of the agglomerates have sizes comprised between 200 and 300 nanometers and still preferably between 200 and 250 nanometers.

The agglomerates have a general zigzag shape, as illustrated for example in FIG. 4 and in FIG. 7. By this it is meant that the agglomerate has the general shape of a broken line. In other words the agglomerate has a general shape which includes several segments having respective inclinations different from each other. The segments are interdependent upon each other.

The general zigzag shape, the size and the structure of the agglomerates are different elements which each contribute to the obtaining of the sought properties once the nanoparticles are dispersed in the fluid coolant. The agglomerates are self-dispersant, i.e. they mix practically instantaneously with the liquid coolant in order to form a homogeneous suspension. The agglomerates only settle slowly. The circulation of the fluid coolant in the cooling circuit, even in the LOCA case, is sufficient for maintaining the quasi-totality of the agglomerates in suspension. Finally, when the agglomerates are dispersed in the fluid coolant, thermal dissipation in the cooling circuit increases very significantly. By this it is meant that the thermal power released by the assemblies of nuclear fuel is better transferred to the fluid coolant, the assemblies thus being maintained at a lower temperature. Also, the fluid coolant more easily yields its thermal energy and is maintained at a moderate temperature. The heat conductivity of a liquid coolant including water and 30% by mass of agglomerates is greater by about 10 to 25% than the heat conductivity of pure water.

Preferably, the nanoparticles are injected into the fluid coolant with a mass titer comprised between 10 and 50%, preferably between 20 and 40% and for example having the value of 30%.

According to another aspect of the invention, the nanoparticles before injection are stored in solid form. They are also injected in solid form into the liquid coolant in the case of an accident. Thus, the device provided for injecting the nanoparticles comprises a storage of said nanoparticles in solid form, and a member for injecting the nanoparticles in solid form from the storage directly into the primary liquid. The member for injecting the nanoparticles for example comprises a member for metering the amount of nanoparticles to be injected, and a means for driving the nanoparticles from the metering member as far as into the coolant circuit. The driving of the nanoparticles is for example accomplished by the means of compressed neutral gas.

The invention has been described above within the scope of an accident of the LOCA type, the nanoparticles being in this case injected into the fluid directly circulating in the core of the reactor. However, the nanoparticles may also be injected when other types of accidents occur which hamper or prevent cooling of the core of the reactor: failure of the piping of the secondary cooling circuit of a reactor of the PWR or other type, connecting the steam generator to the turbine; leak on the secondary cooling circuit; failure of one or several tubes of the steam generator; blocking of the control bars; etc . . . In other words, the invention applies in all the cases when it is necessary to increase the efficiency with which the thermal power released by the nuclear fuel assemblies is discharged out of the core.

The nanoparticles are preferably injected into the so-called primary fluid coolant, which circulates in the core of the reactor. However, it is possible to provide a device adapted for injection into the primary cooling circuit and/or into the secondary cooling circuit, and/or into an optional tertiary cooling circuit of the reactor. The secondary and tertiary circuits are circuits for cooling the core, since they contribute to discharging the heat released in the core.

### BRIEF SUMMARY OF THE DRAWINGS

Other features and advantages of the invention will become apparent from the detailed description thereof which is given below, as an indication and by no means as a limitation, with reference to the appended figures, wherein:

FIG. 1 is a simplified schematic illustration of a nuclear reactor according to the invention;

FIG. 2 is a schematic illustration of first nanoparticles of different types;

FIG. 3 is a simplified schematic illustration of second nanoparticles of different types;

FIG. 4 is a simplified schematic illustration of an agglomerate of nanoparticles; and

FIGS. 5 to 7 illustrate successive steps of the method for producing agglomerates of nanoparticles.

### DETAILED DESCRIPTION

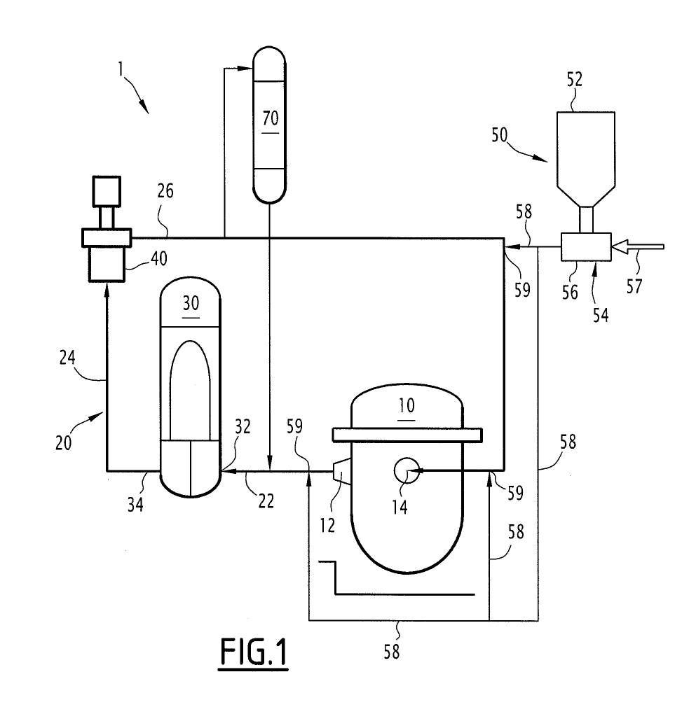

The reactor 1 illustrated in FIG. 1 is a reactor of the PWR type, the reactor 1 includes a vessel 10, in which are placed the assemblies of nuclear fuel forming the core of the reactor, a circuit 20 for cooling the core of the reactor in which circulates a fluid coolant, a steam generator 30 inserted into the cooling circuit 20, a pump 40 for circulating the liquid coolant, itself also inserted into the cooling circuit, and a device 50 provided for injecting nanoparticles into the fluid coolant.

The steam generator 30 includes a primary side in which circulates the fluid for cooling the core, and a secondary side in which circulates a secondary heat transfer fluid. The fluid for cooling the core yields its heat to the secondary fluid crossing the steam generator 30.

The circulation pump 40 is placed downstream from the steam generator 30 according to the circulation direction of the fluid coolant. The cooling circuit 20 includes a hot branch 22 connecting an outlet of fluid coolant 12 from the vessel to a fluid coolant inlet 32 of the steam generator, an intermediate branch 24 connecting a fluid coolant outlet 34 of the steam generator to a suction inlet of the primary pump 40, and a cold branch 26 connecting a discharge outlet of the primary pump 40 to a primary liquid inlet 14 of the vessel. The coolant circuit 20 further includes one or several pressurizers 70.

The device 50 provided for injecting nanoparticles includes a storage 52 for said nanoparticles in solid form and a member 54 for injecting the nanoparticles in solid form from the storage 52 directly into the liquid coolant. The storage 52 is of any suitable type. It may include a pressurized tank of an inert gas in which are stored the nanoparticles, a hopper, etc. The nanoparticles are in the form of agglomerates in the storage 52.

The injection member 54 typically includes a member for metering the nanoparticles to be injected 56, a means 57 for driving the nanoparticles from the metering member 56 as far as into the cooling circuit 20 and one or several lines 58 for transferring the nanoparticles, connecting the metering member 56 to the cooling circuit 20.

The metering member 56 has an inlet communicating with the storage 52. An obturation member, inserted between the storage 52 and the inlet of the metering member 56 selectively gives the possibility of either putting the storage 52 of the metering member 56 into communication or isolating it. The metering member may be of any suitable types. The metering member 56 is for example a receptacle mounted on a weighing cell adapted for measuring the mass of nanoparticles loaded into the receptacle.

The means 57 for driving the nanoparticles from the metering member 56 as far as into the primary circuit for example includes a supply of high pressure inert gas, connected to a gas inlet of the metering member 56. A valve or any other suitable means allows selective triggering or cutting off of the high pressure gas supply in the metering member 56. The transfer lines 58 connect an outlet of the metering member 56 to one or several tappings 59 of the cooling circuit 20. The valves placed on the lines 58 give the possibility of selectively putting the metering member 56 of the cooling circuit 20 into communication or isolating it.

The tappings 59 are placed in selected points of the cooling circuit in order to allow dispersion of the nanoparticles as fast and as effective as possible in the fluid coolant. For example, one of the tappings 59 is immediately placed downstream from the outlet 12 of the vessel. Another tapping 59 may be placed on the cold branch 26, immediately upstream from the inlet 14 of the vessel. Another tapping 59 may be placed in the cold branch 26, at a distance from the circulation pump 40 and at a distance from the vessel 10.

The device 50 is driven by a computer not shown.

In order to achieve injection of nanoparticles into the cooling circuit, the computer first controls the transfer of nanoparticles from the storage 52 as far as into the metering member 56 and then isolates the metering member 56 from the storage 52. It then triggers the inert gas supply of the metering member 56 via the means 57, and the transfer of the nanoparticles from the metering member 56 as far as into the primary circuit 20 via the lines 58. The inert gas pressure provided by the means 57 is greater than the pressure of the liquid coolant in the primary circuit.

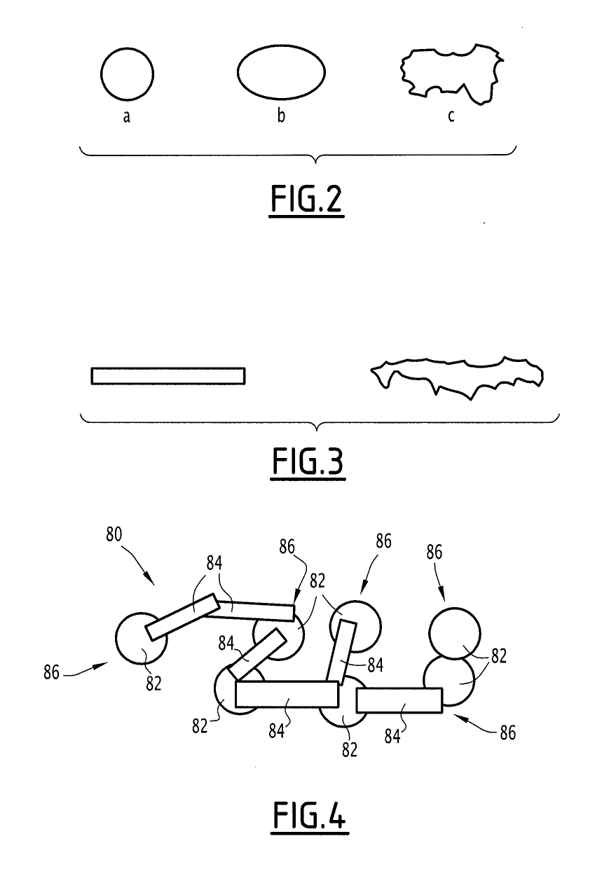

As illustrated in FIG. 2, the first nanoparticles are spherical (Example a) or quasi-spherical (Example b). When they are quasi-spherical, they may have an ovoid shape. The first nanoparticles may further have an irregular shape, as illustrated in Example c of FIG. 2.

As visible in FIG. 3, the second nanoparticles have the shape of elongated rods along a longitudinal direction. In Example a, the rods have a substantially constant cross-section perpendicularly to the longitudinal direction. For example, the section is round or rectangular or of any other shape. In Example b of FIG. 3, the rod may have an irregular cross-section in a plane perpendicular to its longitudinal direction.

As schematically illustrated in FIG. 4, the agglomerates each include a plurality of first nanoparticles 82 and a plurality of second nanoparticles 84 interdependent upon each other. The agglomerate has a general zigzag shape. By this, it is meant that the nanoparticles are positioned so as to form several branches oriented according to respective directions different from each other. The branches are connected with one another. Each branch consists of first nanoparticles and/or of second nanoparticles. The branches are distinct from each other.

The different branches are referenced as 86 in FIG. 4.

FIGS. 5 to 7 illustrate various steps of a first method suitable for producing agglomerates from first and second nanoparticles. In the first step, illustrated in FIG. 5, the polyvinyl alcohol (PVA) rods 88 are mixed with the first and second nanoparticles 82 and 84.

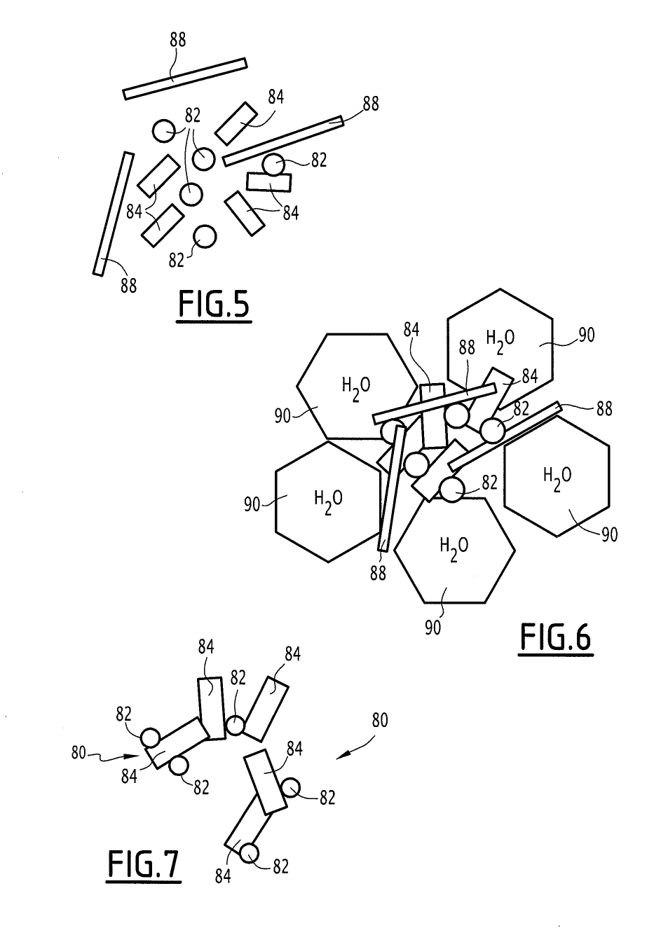

In the second step, illustrated in FIG. 6, quenching of the mixture is carried out at a temperature of about minus 180° C. To do this, a metered amount of water is added to the mixture, the nanoparticles and the PVA rods are dispersed in water, and this dispersion is brought to the temperature of −180° C. The nanoparticles 82 and 84 are then compressed at the interface of the ice crystals 90. The PVA rods 88 play the role of a plasticizer. The agglomerates of nanoparticles are formed during the quenching step, because of the compression between the ice crystals.

The water is then removed by freeze-drying, this step being carried out under cold conditions, at a temperature below 0° C. Finally, after the end of the freeze-drying step, the nanoparticles are dispersed in water. The major portion of the PVA is separated from the nanoparticles either in the vacuum freeze-drying step or during the final dispersion step.

A second method will now be described. It is notably adapted to the production of agglomerates, the first and second particles of which are both in ZnO.

The second method comprises the following steps.)

1°) Preparation of Colloidal Sols of Zinc Oxide Nanoparticles

Two colloidal sols are prepared, the colloidal ZnO sol marketed by Nyacol under reference Nyacol DP5370 and the one marketed by Evonik under reference: VP DISP ZnO 20 DW. Both sols are 35% by weight and contain crystallized nanoparticles. The major difference between them is the shape and the dimension of the nanoparticles: spherical from 30 to 50 nm for Nyacol and in the form of rods or elongated platelets for Evonik (diameter of less than 50 nm, length of 500 to 750 nm). Both sols are sold in a stabilized form and have to be washed in order to remove the organic products and the stabilization salts (dialysis for 5 days on a 14,000 MWCO dialysis membrane in cellulose against 90 liters of DI water). The efficiency of the dialysis is measured by measurements of conductivity of water of the buffer and the final titer of the ZnO is measured by gravimetry after heating to 1000° C. After washing, the mass titers of ZnO are respectively 17% for Nyacol and 14.5% for Evonik.)

2°) Preparation of Agglomerates

### FIRST EXAMPLE

### Agglomerates having 60% Nyacol ZnO+40% Evonik ZnO, by Mass

0.92 g of PVA (Fluka: 4-88) are added to 25 g of DI water. The mixture is stirred at room temperature until total dissolution of the PVA. The PVA solution is added at room temperature to a mixture of 22.2 g of a dialyzed Nyacol ZnO aqueous sol prepared in the previous step (17% by mass of ZnO) and of 17.35 g of dialyzed Evonik ZnO aqueous sol prepared in the previous step (14.5% by mass of ZnO). The reaction medium is milky white, very homogeneous without formation of any precipitate.

The reaction medium is then added dropwise into liquid nitrogen (5 L DEWAR), the diameter of the drops is of about 5 mm. The agglomerates obtained after quenching in liquid nitrogen are then filtered on a plastic Büchner. They are weighed and laid for freeze-drying for 48 hours. Freeze-drying generally lasts for 48 hours. After 36 hours, freeze-drying is stopped and the agglomerates are weighed. They are then laid back for freeze-drying for 12 hours, and they are then reweighed. We consider that freeze-drying is complete if the mass variation between 36 hours and 48 hours does not exceed 0.5 g for 100 g of engaged material. The agglomerates are then conditioned under argon and kept at room temperature.

### SECOND EXAMPLE

### Agglomerates having 80% Nyacol ZnO+20% Evonik ZnO, by Mass

0.92 g of PVA (Fluka: 4-88) are added to 25 g of DI water. The mixture is stirred at room temperature until complete dissolution of the PVA. The PVA solution is added at room temperature to a mixture of 29.6 g of the dialyzed Nyacol ZnO aqueous sol prepared in the previous step (17% by mass of ZnO) and 8.67 g of the dialyzed Evonik ZnO aqueous sol prepared in the previous step (14.5% by mass of ZnO). The reaction medium is milky white, very homogeneous without formation of any precipitate.

The reaction medium is then added dropwise into liquid nitrogen (5 L DEWAR), the diameter of the drops is about 5 mm. The agglomerates obtained after quenching in liquid nitrogen are then filtered on a plastic Buchner. They are weighed and laid for freeze-drying for 48 hours. Freeze-drying generally lasts for 48 hours. After 36 hours, freeze-drying is stopped and the agglomerates are weighed. They are then laid again for freeze-drying for 12 hours and they are then weighed again. We consider that freeze-drying is complete if the mass variation between 36 hours and 48 hours does not exceed 0.5 g for 100 g of engaged material. The agglomerates are then conditioned under argon and kept at room temperature.

### THIRD EXAMPLE

### Agglomerates having 90% Nyacol ZnO+10% Evonik ZnO, by Mass

0.92 g of PVA (Fluka: 4-88) are added to 25 g of DI water. The mixture is stirred at room temperature until complete dissolution of the PVA. The PVA solution is added at room temperature to a mixture of 33.3 g of the dialyzed Nyacol ZnO aqueous sol prepared in the previous step (17% by mass of ZnO) and 4.34 g of the dialyzed Evonik ZnO aqueous sol prepared in the previous step (14.5% by mass of ZnO). The reaction medium is milky white, very homogeneous, without formation of any precipitate. The reaction medium is then added dropwise into liquid nitrogen (5 L DEWAR), the diameter of the drops is about of 5 mm. The agglomerates obtained after quenching in liquid nitrogen are then filtered on a plastic Büchner. They are weighed and laid for freeze-drying for 48 hours. Freeze-drying generally lasts for 48 hours. After 36 hours, freeze-drying is stopped and the agglomerates are weighed. They are then laid back for freeze-drying for 12 hours and then weighed again. We consider that freeze-drying is complete if the mass variation between 36 hours and 48 hours does not exceed 0.5 g for 100 g of engaged material. The agglomerates are then conditioned under argon and kept at room temperature.

What is claimed is:

1-10. (canceled)

11. A nuclear reactor comprising:
a core having nuclear fuel assemblies;
a circuit for cooling the core in which circulates a fluid coolant;
an injector injecting nanoparticles into the fluid coolant, the nanoparticles including first nanoparticles of a first type having a first form factor of less than two, and second nanoparticles of a second type different from the first type having a second form factor greater than two, the nanoparticles comprising between 10% and 90% by weight of the first nanoparticles and between 90% and 10% by weight of the second nanoparticles.

12. The reactor as recited in claim 11 wherein the injector includes a storage for the nanoparticles in solid form and a member for injecting nanoparticles in solid form from the storage directly into the liquid coolant.

13. The reactor as recited in claim 11 wherein the nanoparticles, before injection, are in the form of agglomerates, each agglomerate including first nanoparticles and second nanoparticles.

14. The reactor as recited in claim 13 wherein the agglomerates in majority have sizes comprised between 150 nm and 400 nm.

15. The reactor as recited in claim 13 wherein the agglomerates have a general zigzag shape.

16. The reactor as recited in claim 11 wherein the first nanoparticles have a form factor comprised between 1 and 1.5.

17. The reactor as recited in claim 11 wherein the first nanoparticles are in a mineral oxide, typically selected from Al₂O₃, ZnO, CeO₂ or Fe₂O₃.

18. The reactor as recited in claim 11 wherein that the second nanoparticles have a form factor comprised between 2 and 5.

19. The reactor as recited in claim 11 wherein the second nanoparticles are in a mineral oxide typically selected from Al₂O₃, ZnO, CeO₂ or Fe₂O₃.

20. The reactor as recited in claim 11 wherein the nanoparticles in majority have sizes comprised between 50 nm and 250 nm before agglomeration.
